(19) United States
(12) Patent Application Publication
(10) Pub. No.: US 2004/0012871 A1
(43) Pub. Date: Jan. 22, 2004

(54) Multi-layer film filter-use substrate glass and multi-layer film filter

(76) Inventors: Satoru Yoshihara, Shiga-ken (JP); Masahiro Kobayashi, Shiga-ken (JP); Akihiko Sakamoto, Shiga-ken (JP)

Correspondence Address: J C Patents Inc, 4 Venture Suite 250, Irvine, CA, 92618, US

(21) Appl. No.: 10/257,930

(22) PCT Filed: Jun. 3, 2002
(86) PCT No.: PCT/JP02/05413

(30) Foreign Application Priority Data
Jun. 12, 2001 (JP) 2001-176825
Sep. 10, 2001 (JP) 2001-273138
May 8, 2002 (JP) 2002-132716
May 8, 2002 (JP) 2002-132709

(51) Int. Cl. G02B 5/22

(52) U.S. Cl. 359/885

(57) ABSTRACT

A substrate glass for a multilayer filter is 150 nm or less in flatness within a circle of diameter 50 mm and has a thermal expansion coefficient of 90 to 130×10⁻⁷/° C. at temperatures of −30 to 70 ° C. The substrate glass 150 nm or less in flatness within a circle of diameter 50 mm provides less variations in thickness of film layers. When a plurality of multilayer filters are fabricated from a single sheet of the substrate glass, variations in center wavelength fall within the range of ±100 pm among the multilayer filters, thereby providing improved production yields for the multilayer filters.

### BACKGROUND OF THE INVENTION

The present invention relates to a multilayer filter for use in optical communications and a substrate glass for use with the multilayer filter.

With the recent rapid advancement of optical communication networks, there has been an emerging need for inexpensive high performance optical devices in volume. Among other things, multilayer filters are indispensable as a passive device for transmitting or reflecting light having a particular wavelength to separate or combine the light.

The typical multilayer filters for use in the optical communication field include a band pass filter (BPF) that passes only a narrow bandwidth of light having multiple wavelengths, an edge filter that separates band C (1528 nm to 1561 nm) from band L (1561 nm to 1620 nm), a wide bandwidth filter that separates the center of band C into the short wavelength region (1528 nm to 1545 nm; commonly referred to as a blue band) and the long wavelength region (1545 nm to 1561 nm; commonly referred to as a red band), and a gain equalizer that flattens the gain of an EDFA (erbium doped fiber amplifier).

In general, an optical filter for use with cameras employs plastics as its base material, whereas the aforementioned multilayer filter employs glass having good heat resistance as its base material since laser beams of high intensity impinge thereupon.

In addition, to transmit as much information as possible, it is useful to increase the number of multiplexed wavelengths. However, as the number of multiplexed wavelengths becomes larger, a technique is required that can separate these wavelengths with accuracy. To improve the accuracy of separating wavelengths using a multilayer filter, it is necessary to increase the number of film layers in the multilayer filter. For example, a 100 GHz optical filter (with a multiplexed wavelength spacing of 0.8 nm) requires 20 film layers and the like, while a 50 GHz optical filter (with a multiplexed wavelength spacing of 0.4 nm) requires 100 film layers or more. However, as the number of film layers increases, a stricter property is required of the substrate glass. That is, to maintain the temperature stability of the refraction index of the film layers, the thermal expansion coefficient of the base material is required to be slightly greater than that of the film layers. In addition, to maintain the size stability of the film layers, it is required to increase the Young's modulus of the base material to prevent the base material from being deformed due to the film layers. In Japanese Patent Laid-Open Publication No. 2001-66425, disclosed is a substrate glass having such properties for use with an optical filter.

On the other hand, the recent rapidly expanding optical communication market is demanding a technique of improving the mass productivity to provide the multilayer filter at low prices. However, there is a problem with the aforementioned multilayer filter having many layers that its fabrication yield is low and thus very expensive.

In addition, emphasis has been laid on the machinability of the substrate glass for use with the multilayer filter. That is, to make the multilayer filter, multiple film layers are first formed by vapor deposition or sputtering on a transparent plate-shaped member larger in size than the filter of a final shape, and then the member is cut and ground into the final shape. The transparent plate-shaped member has a thickness of 10 mm or more before deposition to prevent the film layers from being deformed upon deposition, and is then ground as thin as 1 mm in the end. It is thus indispensable to improve the productivity of the grinding process in order to provide the filter at low prices.

Furthermore, the multilayer filter is required to have a good weather resistance to maintain the filter property in a good condition for the long term. This is because when exposed to high temperatures and humidity, the multilayer filter is prone to fogging on the surface of the glass and degradation of the film layers.

However, the substrate glass for optical filters disclosed in Japanese Patent Laid-Open Publication No. 2001-66425 does not meet both the properties of the machinability and weather resistance.

### SUMMARY OF THE INVENTION

It is therefore an object of the present invention to provide a substrate glass for a multilayer filter which maintains the prior-art properties and can be manufactured with high production yields, and a multilayer filter employing the substrate glass.

It is another object of the present invention to provide a substrate glass for a multilayer filter which has good machinability and weather resistance, and is therefore provided at low prices and allows the film layers to be less prone to deterioration for the long term, and a multilayer filter employing the substrate glass.

The present invention is proposed in accordance with the following findings that have been obtained as a result of the intensive studies made by the inventers. That is, in general, to make a multilayer filter, multiple film layers are first formed by vapor deposition or sputtering on a glass substrate larger in size than a final shape, and then the substrate is cut and ground into the final shape. It has been found that the higher the flatness of the glass substrate larger in size than the final shape, the less the variations in thickness of the film layers. With less variations in thickness of the film layers, less variations in center wavelength are provided among the multilayer filters when a plurality of multilayer filters are fabricated from a single sheet of the substrate glass. This allows for providing improved production yields for the multilayer filters.

That is, the substrate glass for a multilayer filter of the invention is characterized by being 200 nm or less in flatness within a circle of diameter 50 mm and has a thermal expansion coefficient of 90 to 130×10⁻⁷/° C. at temperatures of −30 to 70° C.

Furthermore, the multilayer filter of the invention is characterized by employing a substrate glass that can be 200 nm or less in flatness within a circle of diameter 50 mm and has a thermal expansion coefficient of 90 to 130×10⁻⁷/° C. at temperatures of −30 to 70° C. Furthermore, a substrate glass for a multilayer filter is proposed as the present invention in accordance with the finding that has been obtained as a result of the intensive studies made by the inventers. That is, such a substrate glass has been found that provides good machinability and can be ground at high grinding speeds. The substrate glass is also inexpensive and less prone to degradation in the property of the filter for the long term since the glass provides good weather resistance.

That is, the substrate glass for a multilayer filter of the invention is characterized by being ground by lapping at a speed of 10 μm/min or more, with a decrease in mass of 0.05 wt %/hr or less in a boiling water bath and 0.20 wt %/hr or less in a 0.01N nitric acid solution.

Furthermore, the multilayer filter of the invention is characterized by employing a substrate glass that can be ground by lapping at a speed of 10 μm/min or more, with a decrease in mass of 0.05 wt %/hr or less in a boiling water bath and 0.20 wt %/hr or less in a 0.01N nitric acid solution.

The speed of grinding by lapping is evaluated such that a plate-shaped sample is machined while being held in place on a lapping plate rotating horizontally with a vertical load being applied thereto and a lapping agent being supplied thereto, and a decrease in mass of the plate-shaped sample is measured. The lapping conditions employed then are such that the lapping load is 30 to 50 kPa, the rotational speed of the lapping plate is 50 to 200 rpm, the distance between the center of the lapping plate to the center of the plate-shaped sample is 5 to 20 cm, and the lapping agent is a slurry of #1200 alumina powder and water in a mass ratio of 1:10 to 1:50.

### BRIEF DESCRIPTION OF THE DRAWINGS

In the accompanying drawings:

FIG. 1 is a view showing an example of flatness measurements in a embodiment 1 according to the present invention; and

FIG. 2 is a view showing a transmittance curve in the infrared region according to a embodiment 2 of the invention.

### DETAILED DESCRIPTION OF THE PREFERRED EMBODIMENTS

The glass substrate for a multilayer filter according to the invention is 200 nm or less in flatness or preferably 150 nm or less within a circle of diameter 50 mm, thereby providing less variations in thickness of film layers. When a plurality of multilayer filters are fabricated from a single sheet of the substrate glass, variations in center wavelength fall within the range of ±100 pm among the multilayer filters, thereby providing improved production yields for the multilayer filters.

As used herein, the term “flatness” refers to the difference (P−V) between the highest portion (P) and the lowest portion (V) in the undulation of a planar surface that is scanned and thereby measured in a given direction with a laser interferometer (F601 analyzer system by FUJINON).

It is desirable to employ the following methods to provide a flatness of 200 nm or less within a circle of diameter 50 mm for a substrate glass for use with the multilayer filter.

First, a 10 t×100 mmφ sheet of glass is prepared and coarsely ground by a double-side grinder. After this step, a flatness of 1 μm (1000 nm) or less can be achieved within a circle of diameter 50 mm. Then, using the double-side grinder, finish grinding is carried out on the plate-shaped glass that has been coarsely ground. After this step, a flatness of 300 nm or less can be achieved within a circle of diameter 50 mm. Finally, the plate glass that has been finish ground is loaded onto a carrier to polish a surface on which film layers are to be formed, that is to carry out finish polishing on a single side, thereby provide a flatness of 200 nm or less within a circle of diameter 50 mm.

On the other hand, the substrate glass for a multilayer filter of the invention has a thermal expansion coefficient of 90 to 130×10⁷/°, preferably 95×10⁻⁷/° C. or more, or 120×10⁻⁷/° C. or less at temperatures of −30 to 70° C. This allows the difference in thermal expansion coefficient between the substrate glass and the film layers to provide sufficient compressive stress to the film layers, thereby providing a temperature dependency of the center wavelength of the multilayer filter of 1 pm/° C. or less. That is, with a thermal expansion coefficient being less than 90×10⁻⁷/° C., the multilayer filter has a temperature dependency of center wavelength greater than 1 pm/° C. In this case, any neighboring wavelengths may interfere with each other. On the other hand, with a thermal expansion coefficient being greater than 130×10⁻⁷/° C., the film layers may be stripped off the substrate glass, thereby causing the multilayer filter not to serve as a filter any more.

Furthermore, the substrate glass for a multilayer filter of the invention has preferably a Young's modulus of 75 GPa or more, so that the substrate glass is not deformed due to the film layers to thereby provide size stability for the film layers.

On the other hand, the substrate glass for a multilayer filter of the invention can be ground by lapping at a speed of 10 μm/min or more, with a decrease in mass of 0.05 wt %/hr or less in a boiling water bath and 0.20 wt %/hr or less in a 0.01N nitric acid solution. This makes the substrate glass inexpensive and less prone to degradation in filter property for the long term. That is, grinding speeds of below 10 μm/min in lapping would provide bad machinability for the substrate glass and require a long time for machining, thereby impairing the productivity of the multilayer filter and making it impossible to reduce the manufacturing costs thereof. In addition, a decrease in mass of greater than 0.05 wt %/hr in a boiling water bath and greater than 0.20 wt %/hr in a 0.01N nitric acid solution would cause the weather resistance of the multilayer filter to be degraded. This would make the multilayer filter prone to fogging on the glass surface and degradation in the film layers when exposed to high temperatures and humidity for the long term. As used herein, the term “machinability” mentioned above applies to the grinding, cutting, and mirror-finish polishing of glass.

The method for measuring the decrease in mass of glass to evaluate the weather resistance is based on “Measuring Method for Chemical Durability of Optical Glass (Powder Method) 06-1975” in the Japanese Optical Glass Industrial Standards (JOGIS).

A substrate glass having the aforementioned thermal expansion coefficient, Young's modulus, and weather resistance may preferably contain, in mass %, 30 to 60% of SiO₂ and 5 to 33% of Li₂O+Na₂O+K₂O. More preferably, the substrate glass may contain, in mass %, 30 to 60% of SiO₂, 1 to 10% of Al₂O₃, 0 to 20% of B₂O₃, 3 to 35% of MgO+CaO+BaO+SrO+ZnO, 5 to 33% of Li₂O+Na₂O+K₂O, 1 to 30% of TiO₂+ZrO₂, and 0 to 10% of Gd₂O₃+La₂O₃.

Now, described below is the reason for limiting the component content to the aforementioned percentages.

SiO₂ is a component for forming the network of glass and provides an effect of improving weather resistance for the glass. More preferably, the glass may contain 40 to 55% of SiO₂. A content of SiO₂ greater than 60% may tend to provide reduced the thermal expansion coefficient for the glass, increased temperature dependency of the center wavelength of the multilayer filter, lowered grinding speeds for the glass, and cause the glass to be formed with difficulty. On the other hand, with a content of SiO₂ less than 30%, the glass may have increased the thermal expansion coefficient, thereby causing the film layers to be easily stripped off the substrate glass and significantly degraded in weather resistance.

Li₂O, Na₂O, and K₂O increase the thermal expansion coefficient and improve machinability, in particular, more preferably with their total content of 10 to 33%. A content of Li₂O+Na₂O+K₂O less than 5% may degrade the machinability of the glass and lower the thermal expansion coefficient of the substrate glass. A content of more than 33% may unpreferably cause the thermal expansion coefficient to increase and the weather resistance to be degraded.

Like SiO₂, Al₂O₃ is another component for forming the network of glass and provides a effect of preventing the elution of alkali components from the glass, thereby providing remarkably improved weather resistance for the glass. It is thus desirable to contain 1% or more of Al₂O₃. An Al₂O₃ content of more than 10% may tend to cause the grinding speed to be lowered.

B₂O₃ serves as a flux to help the glass to melt, in particular, more preferably with a B₂O₃ content of 0 to 10%. A B₂O₃ content of more than 20% may tend to provide significantly degraded weather resistance and lowered grinding speeds, also induce a stria due to an increase in volatilization when the glass is melted, thereby making it difficult to provide a homogeneous glass.

MgO, CaO, BaO, SrO, and ZnO serve as a flux to help the glass to melt, allowing the glass to be ground at a higher grinding speed and improved in machinability and weather resistance, in particular, more preferably with their total content of 3 to 30%. More than 35% of MgO+CaO+BaO+SrO+ZnO may tend to increase the thermal expansion coefficient, thereby causing the film layers to be stripped off the substrate glass and the weather resistance to be degraded. A content of less then 3% may tend to reduce the thermal expansion coefficient of the glass, increase the temperature dependency of the center wavelength of the multilayer filter, lower the grinding speed for the glass, and decrease machinability, also cause the glass to melt with difficulty.

TiO₂ and ZrO₂ have an effect of increasing the thermal expansion coefficient while maintaining the weather resistance, in particular, more preferably with their total content of 1 to 20%. A TiO₂+ZrO₂ content of more than 30% may tend to make the glass devitrify, whereas their content of less than 1% makes it difficult to provide a high thermal expansion coefficient.

Gd₂O₃ and La₂O₃ serve to improve the weather resistance without significantly degrading the thermal expansion coefficient, in particular, more preferably with their total content of 0 to 8%. A Gd₂O₃+La₂O₃ content of more than 10% would tend to lower the thermal expansion coefficient.

In addition to the aforementioned components, the glass of the invention can contain a fining agent such as Sb₂O₃. However, As₂O₃ is not preferred from the environmental viewpoint and thus may not be employed.

Furthermore, a substrate glass having the aforementioned good machinability and weather resistance may not substantially contain PbO but preferably contain, in mass %, (SiO₂+Al₂O₃+B₂O₃+P₂O₅)/(MgO+CaO+BaO+SrO+ZnO+Li₂O+Na₂O+K₂O)≦1.55 and 5 to 33% of Li₂O+Na₂O+K₂O. More preferably, a substrate glass may not substantially contain PbO but contain, in mass %, 30 to 60% of SiO₂, 1 to 10% of Al₂O₃, 0 to 20% of B₂O₃, 15 to 35% of MgO+CaO+BaO+SrO+ZnO, 10 to 33% of Li₂O+Na₂O+K₂O, (SiO₂+Al₂O₃+B₂O₃+P₂O₅)/(MgO+CaO+BaO+SrO+ZnO+Li₂O+Na₂O+K₂O)≦1.55, 1 to 10% of TiO₂+ZrO₂, and 0 to 10% of Gd₂O₃+La₂O₃.

Now, described below is the reason for limiting the component content to the aforementioned percentages.

PbO lowers the weather resistance and is not preferred from the environmental viewpoint. It is therefore preferable not to contain PbO in the glass.

When ΣA is the total content of SiO₂, Al₂O₃, B₂O₃, and P₂O₅, while ΣB is the total content of MgO, CaO, BaO, SrO, ZnO, Li₂O, Na₂O, and K₂O. If ΣA/ΣB is greater than 1.55, then the glass network formers are relatively richer. This tends to cause the glass to contain less non-bridging-bonds in its structure and thus its grinding speeds to be reduced. On the other hand, ΣA/ΣB greater than 0.80 would preferably provide a good weather resistance.

Li₂O, Na₂O, and K₂O improve machinability, in particular, more preferably with their total content of 10 to 33%. A Li₂O+Na₂O+K₂O content of more than 33% would unpreferably provide increased thermal expansion coefficient and decreased weather resistance of the substrate glass. On the other hand, a content of less than 5% would tend to unpreferably provide degraded machinability and reduced thermal expansion coefficient of the substrate glass.

SiO₂ is a component for forming the network of glass and provides an effect of improving weather resistance of the glass. In particular, the glass may contain more preferably 40 to 55% of SiO₂. A content of SiO₂ greater than 60% may tend to provide lowered grinding speeds for the glass and cause the glass to be formed with difficulty. On the other hand, with a content of less than 30%, the glass may be significantly degraded in weather resistance.

Like SiO₂, Al₂O₃ is another component for forming the network of glass and provides a effect of preventing the elution of alkali components from the glass, thereby providing remarkably improved weather resistance for the glass. It is thus desirable to contain 1% or more of Al₂O₃. An Al₂O₃ content of more than 10% may tend to cause the grinding speed to be lowered.

B₂O₃ serves as a flux to help the glass to melt, in particular, more preferably with a B₂O₃ content of 0 to 10%. A B₂O₃ content of more than 20% may tend to provide significantly degraded weather resistance and lowered grinding speeds, also induce a stria due to an increase in volatilization when the glass is melted, thereby making it difficult to provide a homogeneous glass.

MgO, CaO, BaO, SrO, and ZnO serve as a flux to help the glass to melt, allowing the glass to be ground at higher speeds and improved in machinability, in particular, more preferably with their total content of 20 to 30%. More than 35% of MgO+CaO+BaO+SrO+ZnO may tend to degrade the weather resistance, while their content of less then 15% may tend to cause the glass to be ground at lower grinding speeds and degraded in machinability.

TiO₂ and ZrO₂ have an effect of increasing the thermal expansion coefficient while maintaining the weather resistance, in particular, more preferably with their total content of 1 to 8%. A TiO₂+ZrO₂ content of more than 10% may tend to make the glass devitrify, whereas their content of less than 1% makes it difficult to provide a high thermal expansion coefficient.

Gd₂O₃ and La₂O₃ serve to improve the weather resistance without significantly degrading the thermal expansion coefficient, in particular, more preferably with their total content of 0 to 8%. A Gd₂O₃+La₂O₃ content of more than 10% would tend to lower the thermal expansion coefficient.

In addition to the aforementioned components, the glass of the invention can contain a fining agent such as Sb₂O₃. However, As₂O₃ is not preferred from the environmental viewpoint and thus may not be employed.

On the other hand, the substrate glass for a multilayer filter of the invention may preferably have a minimum transmittance of 80% or more, more preferably 88% or more, at a thickness of 10 mm within the range of wavelengths from 950 to 1650 nm to provide a low optical attenuation within any range of the wavelengths for use in optical communications. As used herein, the term “minimum transmittance” means the lowest transmittance within the range of wavelengths from 950 to 1650 nm. The OH groups in the glass cause the absorption of light having wavelengths around 1400 nm to thereby reduce the intensity of the light. Thus, it is desirable to reduce the amount of OH groups in the glass as much as possible in order to use the light having wavelengths around 1400 nm.

On the other hand, if the substrate glass for a multilayer filter of the invention having an internal transmittance of 98% or less at thickness of 1 mm and at a wavelength of 1550 nm, it may not be used because of lowering of the light intensity.

Now, the substrate glass for a multilayer filter of the invention and the multilayer filter are described in more detail in accordance with the embodiments.

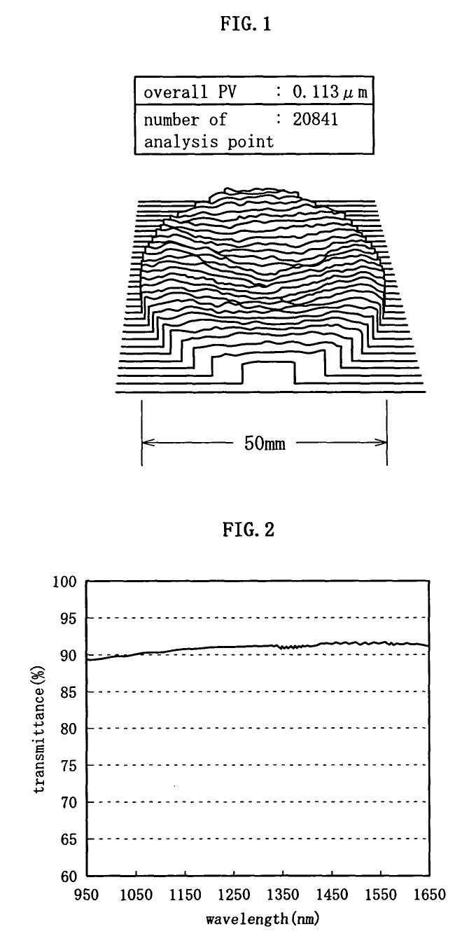

Tables 1 to 3 are related to embodiments 1 to 12 of the invention and Tables 4, 5 are related to comparative examples 1 to 6. FIG. 1 illustrates an example of flatness measurements in embodiment 1 and FIG. 2 illustrates a transmittance curve in the infrared region of embodiment 2.

TABLE 1

| | | Embodiment | Embodiment | Embodiment | Embodiment | Embodiment |
|---|---|---|---|---|---|---|
| Mass % | | 1 | 2 | 3 | 4 | 5 |
| A | SiO₂ | 46.8 | 46.8 | 51.8 | 39.8 | 42.8 |
| | Al₂O₃ | 3.0 | 3.0 | 3.0 | 3.0 | 8.0 |
| | B₂O₃ | — | — | — | — | — |
| | P₂O₅ | — | — | — | — | — |
| B | MgO | 8.0 | — | — | — | — |
| | CaO | 3.0 | 11.0 | 10.0 | 13.0 | 11.0 |
| | BaO | 8.0 | 8.0 | 6.0 | 9.0 | 7.0 |
| | SrO | 5.0 | 8.0 | 6.0 | 9.0 | 7.0 |
| | ZnO | 3.0 | — | — | — | — |
| | Li₂O | 9.0 | 9.0 | 10.0 | 10.0 | 7.0 |
| | Na₂O | 7.0 | 7.0 | 5.0 | 10.0 | 5.0 |
| | K₂O | — | — | — | — | — |

| | | | | | |
|---|---|---|---|---|---|
| TiO₂ | 2.0 | 2.0 | 2.0 | 2.0 | 5.0 |
| ZrO₂ | 1.0 | 1.0 | 1.0 | 1.0 | 3.0 |
| La₂O₃ | — | — | — | — | — |
| Gd₂O₃ | 4.0 | 4.0 | 5.0 | 3.0 | 4.0 |
| Sb₂O₃ | 0.2 | 0.2 | 0.2 | 0.2 | 0.2 |
| εA/εB | 1.16 | 1.16 | 1.48 | 0.84 | 1.38 |
| Flatness | 120 | 110 | 145 | 85 | 95 |
| (Maximum) | | | | | |
| (nm) | | | | | |
| Flatness | 100 | 90 | 120 | 70 | 80 |
| (Average) | | | | | |
| (nm) | | | | | |
| Thermal expansion | 109 | 110 | 102 | 118 | 100 |
| coefficient | | | | | |
| (x10⁻⁷/° C.) | | | | | |
| Grinding speed | 50 | 60 | | | 30 |
| (μm/min) | | | | | |
| Water resistance | 0.01 | 0.02 | 0.01 | 0.03 | 0.01 |
| (wt %) | | | | | |
| Acid resistance | 0.05 | 0.07 | 0.04 | 0.15 | 0.04 |
| (wt %) | | | | | |
| Young's modulus | 93 | 95 | 96 | 89 | 90 |
| (GPa) | | | | | |
| Minimum | 91 | 89 | 92 | 91 | 90 |
| transmittance | | | | | |
| (%) at 10 mm | | | | | |
| thickness | | | | | |
| Internal | 99 | 99 | | | 99 |
| transmittance | | | | | |
| (%) | | | | | |
| at 1 mm | | | | | |
| in calculated | | | | | |
| thickness | | | | | |
| at 1550 nm | | | | | |
| Production Yield | 25 | 30 | 25 | 35 | 35 |
| (%) | | | | | |
| Temperature | 0.7 | 0.6 | 0.8 | 0.4 | 0.5 |
| dependency of | | | | | |
| center wavelength | | | | | |
| (pm/° C.) | | | | | |

TABLE 2

| | | Embodiment | Embodiment | Embodiment | Embodiment | Embodiment |
|---|---|---|---|---|---|---|
| [symbol] % | | 6 | 7 | 8 | 9 | 10 |
| A | SiO₂ | 43.8 | 42.8 | 47.8 | 47.8 | 39.8 |
| | Al₂O₃ | 3.0 | 3.0 | 3.0 | 2.0 | — |
| | B₂O₃ | — | 10.0 | — | — | 2.0 |
| | P₂O₅ | — | — | — | — | — |
| B | MgO | — | — | — | 5.0 | — |
| | CaO | 9.0 | 10.0 | 11.0 | — | — |
| | BaO | 10.0 | 7.0 | 8.0 | — | 4.0 |
| | SrO | 11.0 | 7.0 | 6.0 | — | — |
| | ZnO | | — | — | 2.0 | — |
| | Li₂O | 9.0 | 7.0 | 8.0 | — | 2.0 |
| | Na₂O | 7.0 | 6.0 | 7.0 | 18.0 | 14.0 |
| | K₂O | — | — | — | 10.0 | 9.0 |

| | | | | | |
|---|---|---|---|---|---|
| TiO₂ | 2.0 | 2.0 | 2.0 | 15.0 | 29.0 |
| ZrO₂ | 1.0 | 1.0 | 1.0 | — | — |
| La₂O₃ | 4.0 | 4.0 | 3.0 | — | — |
| Gd₂O₃ | — | — | 3.0 | — | — |
| Sb₂O₃ | 0.2 | 0.2 | 0.2 | 0.2 | 0.2 |
| εA/εB | 1.02 | 1.51 | 1.28 | 1.42 | 1.44 |
| Flatness | 115 | 120 | 130 | 120 | 110 |
| (Maximum) | | | | | |
| (nm) | | | | | |
| Flatness | 90 | 90 | 110 | 100 | 90 |
| (Average) | | | | | |
| (nm) | | | | | |
| Thermal expansion | 105 | 108 | 108 | 112 | 100 |
| coefficient | | | | | |
| (x10⁻⁷/° C.) | | | | | |
| Grinding speed | 65 | 55 | 60 | | |
| (μm/min) | | | | | |
| Water resistance | 0.03 | 0.03 | 0.03 | 0.02 | 0.03 |
| (wt %) | | | | | |
| Acid resistance | 0.17 | 0.10 | 0.09 | 0.09 | 0.10 |
| (wt %) | | | | | |
| Young's modulus | 88 | 95 | 95 | 100 | 85 |
| (GPa) | | | | | |
| Minimum | 92 | 90 | 89 | 90 | 90 |
| transmittance | | | | | |
| (%) at 10 mm | | | | | |
| thickness | | | | | |
| Internal | 99 | 99 | 99 | | |
| transmittance | | | | | |
| (%) | | | | | |
| at 1 mm | | | | | |
| in calculated | | | | | |
| thickness | | | | | |
| at 1550 nm | | | | | |
| Production Yield | 30 | 30 | 25 | 25 | 35 |
| (%) | | | | | |
| Temperature | 0.6 | 0.6 | 0.8 | 0.6 | 0.7 |
| dependency of | | | | | |
| center wavelength | | | | | |
| (pm/° C.) | | | | | |

TABLE 3

| | | Embodiment | Embodiment |
|---|---|---|---|
| [symbol] % | | 11 | 12 |
| A | SiO₂ | 49.8 | 39.8 |
| | Al₂O₃ | 3.0 | 3.0 |
| | B₂O₃ | — | — |
| | P₂O₅ | 2.0 | — |
| B | MgO | — | — |
| | CaO | 10.0 | 13.0 |
| | BaO | 6.0 | 9.0 |
| | SrO | 6.0 | 9.0 |
| | ZnO | — | — |
| | Li₂O | 10.0 | 10.0 |
| | Na₂O | 5.0 | 8.0 |
| | K₂O | — | 2.0 |

| | | |
|---|---|---|
| TiO₂ | 2.0 | 2.0 |
| ZrO₂ | 1.0 | 1.0 |
| La₂O₃ | — | — |
| Gd₂O₃ | 5.0 | 3.0 |
| Sb₂O₃ | 0.2 | 0.2 |
| εA/εB | 1.49 | 0.84 |
| Flatness | 155 | 85 |
| (Maximum) | | |
| (nm) | | |
| Flatness | 120 | 70 |
| (Average) | | |
| (nm) | | |
| Thermal expansion | 102 | 118 |
| coefficient | | |
| (x10⁻⁷/° C.) | | |
| Grinding speed | 40 | 70 |
| (μm/min) | | |
| Water resistance | 0.01 | 0.03 |
| (wt %) | | |
| Acid resistance | 0.04 | 0.15 |
| (wt %) | | |
| Young's modulus | | |
| (GPa) | | |
| Minimum | | |
| transmittance | | |
| (%) at 10 mm | | |
| thickness | | |
| Internal | 99 | 98 |
| transmittance | | |
| (%) | | |
| at 1 mm | | |
| in calculated | | |
| thickness | | |
| at 1550 nm | | |
| Production Yield | | |
| (%) | | |
| Temperature | | |
| dependency of | | |
| center wavelength | | |
| (pm/° C.) | | |

TABLE 4

| | | Comparative | Comparative | Comparative | Comparative |
|---|---|---|---|---|---|
| Mass % | | example 1 | example 2 | example 3 | example 4 |
| A | SiO₂ | 46.8 | 71.4 | 36.8 | 48.8 |
| | Al₂O₃ | 3.0 | — | 3.0 | 8.0 |
| | B₂O₃ | — | 6.5 | 22.0 | — |
| | P₂O₅ | — | — | — | — |
| B | MgO | — | — | — | — |
| | CaO | 11.0 | 2.0 | 8.0 | 12.0 |
| | BaO | 8.0 | — | 6.0 | 10.0 |
| | SrO | 8.0 | — | 6.0 | 9.0 |
| | ZnO | — | — | — | — |
| | Li₂O | 9.0 | — | 7.0 | 4.0 |
| | Na₂O | 7.0 | 5.2 | 5.0 | — |
| | K₂O | — | 13.9 | — | — |

| | | | | |
|---|---|---|---|---|
| TiO₂ | 2.0 | — | 2.0 | 2.0 |
| ZrO₂ | 1.0 | — | 1.0 | 1.0 |
| La₂O₃ | — | — | — | 5.0 |
| Gd₂O₃ | 4.0 | — | 3.0 | — |
| Sb₂O₃ | 0.2 | — | 0.2 | — |
| εA/εB | 1.16 | 3.69 | 1.94 | 1.63 |
| Flatness | 360 | 50 | 335 | 350 |
| (Maximum) | | | | |
| (nm) | | | | |
| Flatness | 300 | 40 | 280 | 290 |
| (Average) | | | | |
| (nm) | | | | |
| Thermal expansion | 110 | 72 | 105 | 90 |
| coefficient | | | | |
| (x10⁻⁷/° C.) | | | | |
| Grinding speed | | | 110 | 8 |
| (μm/min) | | | | |
| Water resistance | 0.02 | 0.07 | 0.12 | 0.01 |
| (wt %) | | | | |
| Acid resistance | 0.07 | 0.15 | 0.32 | 0.03 |
| (wt %) | | | | |
| Young's modulus | 95 | 80 | | |
| (GPa) | | | | |
| Minimum | 90 | 91 | | |
| transmittance | | | | |
| (%) at 10 mm | | | | |
| thickness | | | | |
| Internal | | | 99 | 99 |
| transmittance | | | | |
| (%) | | | | |
| at 1 mm | | | | |
| in calculated | | | | |
| thickness | | | | |
| at 1550 nm | | | | |
| Production Yield | 5 | 35 | | |
| (%) | | | | |
| Temperature | 0.7 | 4.2 | | |
| dependency of | | | | |
| center wavelength | | | | |
| (pm/° C.) | | | | |

TABLE 5

| | | Comparative | Comparative |
|---|---|---|---|
| Mass % | | example 5 | example 6 |
| A | SiO₂ | 17.1 | 47.0 |
| | Al₂O₃ | — | — |
| | B₂O₃ | 21.5 | 7.1 |
| | P₂O₅ | — | — |
| B | MgO | 1.0 | — |
| | CaO | — | — |
| | BaO | — | 10.0 |
| | SrO | 14.8 | — |
| | ZnO | — | 6.1 |
| | Li₂O | 8.5 | — |
| | Na₂O | — | 6.0 |
| | K₂O | — | 14.0 |

| | | |
|---|---|---|
| TiO₂ | 7.6 | — |
| ZrO₂ | 4.5 | — |
| La₂O₃ | 17.0 | — |
| Gd₂O₃ | — | — |
| PbO | — | 9.7 |
| Nb₂O₅ | 7.9 | — |
| Sb₂O₃ | 0.1 | 0.1 |
| εA/εB | 1.59 | 1.18 |
| Flatness | 300 | 290 |
| (Maximum) | | |
| (nm) | | |
| Flatness | 250 | 240 |
| (Average) | | |
| (nm) | | |
| Thermal expansion | 90 | 88 |
| coefficient | | |
| (x10⁻⁷/° C.) | | |
| Grinding speed | 9 | 50 |
| (μm/min) | | |
| Water resistance | 0.07 | 0.06 |
| (wt %) | | |
| Acid resistance | 0.20 | 0.22 |
| (wt %) | | |
| Young's modulus | | |
| (GPa) | | |
| Minimum | | |
| transmittance | | |
| (%) at 10 mm | | |
| thickness | | |
| Internal | 97 | 99 |
| transmittance | | |
| (%) | | |
| at 1 mm | | |
| in calculated | | |
| thickness | | |
| at 1550 nm | | |
| Production Yield | | |
| (%) | | |
| Temperature | | |
| dependency of | | |
| center wavelength | | |
| (pm/° C.) | | |

The samples used in embodiments 1 to 12 and comparative examples 1 to 6, which are shown in Tables 1 to 5, were fabricated as follows.

First, glass raw materials were prepared to have the compositions as shown in Tables 1 to 5. Each of the preparations was melted in a platinum crucible for four hours at temperatures of 1300 to 1500° C., and then the melt was allowed to flow out onto a carbon plate and then annealed to obtain a glass block.

The aforementioned glass block was cut into a disc of diameter 76 mm and thickness 10 mm and then coarsely ground using a double-side grinder with a lapping plate of 280 mm in diameter. The conditions employed then for the coarse grinding are as follows.

The coarse grinding was carried out in two steps;

alumina of #400 was used as an abrasive in the first step and alumina of #1200 was used in the second step. At the center of the carrier, the relative speed between the work and the lapping plate was set to 30 m/min and the grinding load to 120 g/cm².

A glass plate that was made 7.05 mm in thickness through the aforementioned coarse grinding had a flatness of 1 μm (1000 nm) or less within a circle of diameter 50 mm. Then, the glass plate after having been coarsely ground was subjected to finish grinding using a double-side grinder having a lapping plate of 280 mm in diameter. The conditions employed then for the finish grinding are as follows.

A pad containing cerium oxide was employed as a grinding pad, and a cerium oxide based abrasive was employed as an abrasive. At the center of the carrier, the relative speed between the work and the polishing plate was set to 30 m/min and the grinding load to 120 g/cm².

A glass plate that was made 7.005 mm in thickness through the aforementioned finish grinding had a flatness of 300 nm or less within a circle of diameter 50 mm.

Finally, the finish-ground glass plate was subjected to a final single-side finish polishing with the surface of the plate, on which film layers are to be formed, being placed on the pad surface. The conditions for the final single-side finish polishing are as follows.

A single-side grinder with a polishing plate of 280 mm in diameter was used, a cerium pad was employed as a grinding pad, and a cerium oxide based abrasive was employed as an abrasive. At the center of the carrier, the relative speed between the work and the polishing plate was set to 10 m/min and the polishing load to 40 g/cm².

The substrate glasses for each of the embodiments 1 to 12 and comparative example 2 that were made 7.000 mm in thickness as described above had a flatness of 200 nm or less within a circle of diameter 50 mm as shown in Tables 1 to 4. On the other hand, comparative examples 1 and 3 to 6 were fabricated entirely in the same manner as the embodiments except that they were not subjected to the final single-side finish polishing.

Subsequently, dielectric films of Ta₂O₅ and SiO₂ were alternately deposited to a total of 100 layers on the aforementioned glass substrates using an ion-assisted vapor deposition system, thereby fabricating multilayer filters.

The 20 sheets of substrate glasses were measured to determine their maximum and average flatness in accordance with the aforementioned method. The speed of grinding by lapping was evaluated such that a plate-shaped sample having a side of 25 mm and a thickness of 3 mm was machined while being held in place on a lapping plate of cast iron that was rotating horizontally with a vertical load being applied thereto and a lapping agent being supplied thereto, and a decrease in mass of the sample glass was measured. The lapping conditions employed then were such that the lapping load was 35 kPa, the rotational speed of the lapping plate was 10 rpm, the distance between the center of the lapping plate to the center of the plate-shaped sample was 10 cm, and the lapping agent was a slurry having a mass ratio of 1 to 20 of #1200 alumina powder to water.

The thermal expansion coefficient was measured using a dilatometer (TD-5000S by MAC Science).

The water resistance and acid resistance were evaluated as follows in accordance with “Measuring Method for Chemical Durability of Optical Glass (Powder Method) 06-1975” in the Japanese Optical Glass Industrial Standards (JOGIS). That is, a glass sample was crashed into glass powder of grain size 420 to 590 μm, a specific gravity gram of which was weighed to be put into a platinum basket and then into a flask containing a reagent therein. The glass powder in the flask was then treated for 60 minutes in a bath of boiling water. Finally, a decrease in mass (mass %) of the treated glass powder was calculated. The reagent employed in the evaluation of resistance to water was a pure water having an adjusted pH of 6.5 to 7.5, while the reagent employed in the evaluation of resistance to acid was a nitric acid solution adjusted to 0.01N. The Young's modulus was measured by ultrasonic pulse method using an ultrasonic flaw detector FD-1800 made by Mitsubishi Electric.

The measurement of the minimum transmittance was carried out for a sample 10 mm in thickness and having both surfaces optically ground, using a spectrometer UV-3100PC made by Shimazu. The internal transmittance was determined in a manner such that two specimens different in thickness from each other were prepared, which were then measured at a wavelength of 1550 nm using the spectrometer UV-3100PC made by Shimazu, and then the internal transmittance was calculated in terms of thickness 1 mm. The transmittance in the infrared region was measured within the wavelength range of 950 to 1650 nm in terms of thickness 10 mm using the spectrometer UV-3100PC made by Shimazu.

The production yield of the multilayer filter was determined by assuming that good fabricated multilayer filters had a center wavelength that fell within the range of the desired center wavelength ±100 pm.

Furthermore, the temperature dependency of the center wavelength of the multilayer filter was determined by measuring variations in center wavelength around 1550 nm while the filter was being increased in temperature from 0° C. to 70° C., using a spectrum analyzer (Q-8384 made by Advantest).

Embodiments 1 to 12 of the invention provided good flatness and production yields for the multilayer filter, and the temperature dependency of the center wavelength of the multilayer filter was 1 pm/° C. or less due to their high thermal expansion coefficients. The embodiments also provided high grinding speeds and good weather resistance for the multilayer filter. In addition to this, as shown in FIG. 2, embodiment 2 provided a high transmittance in the infrared region and therefore no absorption of light was observed at around 1400 nm.

On the other hand, comparative examples 1 and 3 to 6 were not subjected to final single-side finish polishing in the step of grinding the substrate glass, thereby providing bad flatness and low production yields for the multilayer filters. Comparative example 2 provided good flatness and high production yields for the multilayer filter, but provided a high temperature dependency of the center wavelength of the multilayer filter due to its low thermal expansion coefficient. In addition, since ΣA/ΣB was large, the grinding speed was low and machinability were bad. Comparative example 3 contained a large amount of B₂O₃ and therefore provided a high grinding speed but a low weather resistance. Comparative examples 4, 5 had less alkali components and were therefore good in weather resistance, but provided a low grinding speed and reduced machinability due to a large ΣA/ΣB. Due to a small ΣA/ΣB, comparative example 6 provided a high grinding speed and good machinability, however, it contained PbO and was thus low in weather resistance and not preferred from the environmental viewpoint.

As described above, the substrate glass for a multilayer filter of the invention has a good flatness, thereby providing a high production yield for the multilayer filter and making it possible to fabricate the filter at low costs. The substrate glass has also have a high thermal expansion coefficient, thereby providing reduced the temperature dependency of the center wavelength. Furthermore, due to good machinability and weather resistance, the filter can be fabricated at low costs and made less prone to degradation in the film layers for the long term, thereby made suitable for optical communications.

What is claimed is:

1. A substrate glass for a multilayer filter, the substrate glass being 200 nm or less in flatness within a circle of diameter 50 mm and having a thermal expansion coefficient of 90 to 130×10⁻⁷/° C. at temperatures of −30 to 70° C.

2. The substrate glass for a multilayer filter according to claim 1, wherein the substrate glass has a Young's modulus of 75 GPa or more.

3. The substrate glass for a multilayer filter according to claim 1, wherein the substrate glass has a minimum transmittance of 80% or more at a thickness of 10 mm within a range of wavelengths from 950 to 1650 nm.

4. The substrate glass for a multilayer filter according to claim 1, wherein the substrate glass contains, in mass %, 30 to 60% of SiO₂ and 5 to 33% of Li₂O+Na₂O+K₂O.

5. The substrate glass for a multilayer filter according to claim 1, wherein the substrate glass contains, in mass %, 30 to 60% of SiO₂, 1 to 10% of Al₂O₃, 0 to 20% of B₂O₃, 3 to 35% of MgO+CaO+BaO+SrO+ZnO, 5 to 33% of Li₂O+Na₂O+K₂O, 1 to 30% of TiO₂+ZrO₂, and 0 to 10% of Gd₂O₃+La₂O₃.

6. A substrate glass for a multilayer filter, the substrate glass being ground by lapping at a speed of 10 μm/min or more, with a decrease in mass of 0.05 wt %/hr or less in a boiling water bath and 0.20 wt %/hr or less in a 0.01N nitric acid solution.

7. The substrate glass for a multilayer filter according to claim 6, wherein the substrate glass contains, in mass %, (SiO₂+Al₂O₃+B₂O₃+P₂O₅)/(MgO+CaO+BaO+SrO+ZnO+Li₂O+Na₂O+K₂O)≦1.55 and 5 to 33% of Li₂O+Na₂O+K₂O and substantially does not contain PbO.

8. The substrate glass for a multilayer filter according to claim 6, wherein the substrate glass contains, in mass %, 30 to 60% of SiO₂, 1 to 10% of Al₂O₃, 0 to 20% of B₂O₃, 15 to 35% of MgO+CaO+BaO+SrO+ZnO, (SiO₂+Al₂O₃+B₂O₃+P₂O₅)/(MgO+CaO+BaO+SrO+ZnO+Li₂O+Na₂O+K₂O)≦1.55, 10 to 33% of Li₂O+Na₂O+K₂O, 1 to 10% of TiO₂+ZrO₂, and 0 to 10% of Gd₂O₃+La₂O₃, and substantially does not contain PbO.

9. A multilayer filter using the substrate glass according to claims 1.

10. A multilayer filter using the substrate glass according to claims 2.

11. A multilayer filter using the substrate glass according to claims 3.

12. A multilayer filter using the substrate glass according to claims 4.

13. A multilayer filter using the substrate glass according to claims 5.

14. A multilayer filter using the substrate glass according to claims 6.

15. A multilayer filter using the substrate glass according to claims 7.

16. A multilayer filter using the substrate glass according to claims 8.
